(19) United States
(12) Patent Application Publication
(10) Pub. No.: US 2011/0287382 A1
(43) Pub. Date: Nov. 24, 2011

(54) METHODS OF MAKING AND USING DENTAL ARTICLES FOR TOOTH IMPLANTS AND PREFORMED DENTAL ARTICLES

(76) Inventors: Ryan E. Johnson, St. Paul, MN (US); Naimul Karim, Maplewood, MN (US); Roger K. Dawson, Excelsior, MN (US)

(21) Appl. No.: 13/141,351

(22) PCT Filed: Feb. 3, 2010
(86) PCT No.: PCT/US10/22961

§ 371 Date: Jun. 22, 2011

Related U.S. Application Data
(60) Provisional application No. 61/151,884, filed on Feb. 12, 2009.

(51) Int. Cl. A61C 8/00

(52) U.S. Cl. 433/173; 433/201.1

(57) ABSTRACT

Methods of affixing a dental article to a tooth implant are described and preformed dental articles (e.g. suitable for tooth implants) including kits. In some embodiments, the dental article lacks supragingival exterior surfaces and may be characterized as a healing cap. In other embodiments, the dental article comprises supragingival exterior surfaces and may be characterized as a (e.g. temporary or provisional) crown.

### BACKGROUND

As described for example in the Background of US 2007/0031793, a widely-used form of dental implant fixture, includes a generally cylindrical body which is implanted in a cylindrical bore made in the patient's jawbone (i.e., an endosseous implant) at the site of a edentulous ridge or tooth extraction socket, and having an internally-threaded cylindrical socket in which to fasten components used for attaching a permanent restoration to the implant fixture once the jawbone and gumline are healed. Prior to healing, the abutment is releasably fastened into cylindrical body by screwing threads into the implant socket. Once the abutment is releasably secured in place, the appropriately sized pre-fabricated temporary attachment is placed over abutment such that the void is mated with abutment properly adjusted (interproximally and occlusally), and the crown is secured in place using a suitable temporary dental fixative. The temporary abutment and temporary attachment may generally be left in place for period of time, e.g., 2 months, 3 months, 6 months, etc. sufficient to allow for healing of the patient's jawbone and gumline. Once healed, the temporary attachment may be removed, and a permanent restoration put in place on the implant fixture, as known in the art.

### BRIEF DESCRIPTION OF THE DRAWINGS

FIG. 1 is a perspective view of an embodied preformed dental article affixed to an implant abutment and a cross-sectional view of the adjacent dental tissue.

FIG. 2 is a perspective exploded view of another embodied dental article and tooth implant.

FIG. 3 is a perspective view of another embodiment of a dental article.

### SUMMARY

Even when the implant is covered with a temporary attachment such as a provisional crown or healing cap, the gingival tissue around the extracted tooth typically retracts losing its natural emergence profile, leading to poor esthetics. This gingival tissue retraction is surmised to be caused by the provisional crown or temporary attachment not being properly sized and/or shaped relative to the extracted tooth and subsequent permanent restoration. Often there is a locational or angular misplacement of the implant relative to the neighboring dentition. Such misplacement can be unintentional or intentional, dictated by the primary consideration of available bone structure and/or function of the implant, rather than esthetical consideration.

Accordingly, industry would find advantage in preformed dental articles that can be customized in shape in order to manage the shape of the healing (e.g. gingival and/or internal) dental tissue.

In one embodiment, a method of affixing a dental article to a tooth implant is described. The method comprises providing a preformed dental article comprised of a sufficiently malleable material such that the dental article can be customized in shape; shaping at least a portion of the dental article that contacts gingival tissue or internal tissue beneath the gingival tissue; affixing the dental article to a tooth implant abutment or anchor such that the dental article contacts the gingival tissue and internal tissue; and hardening the dental article.

Typically, the dental article is attached after extraction of a tooth and prior to healing of the gingival and internal tissue. Alternatively, the method can be used in a two-step method, further comprising removing (i.e. healed) dental tissue above the tooth implant abutment or anchor such that the gingival tissue, internal tissue, and tooth implant abutment or anchor are exposed. The method typically further comprises allowing the gingival and internal tissue to heal and replacing the dental article with a permanent restoration.

In another embodiment, a method of providing a permanent restoration for a tooth implant is described. The method comprises removing a temporary dental article from an implant abutment or anchor, wherein the temporary dental article contacts the internal tissue beneath the gingival tissue and is formed from a hardened photocured material; and affixing a permanent restoration to the implant abutment or anchor.

In other embodiments, preformed dental articles are described that and are sufficiently malleable such that (e.g. gingival and/or subgingival exterior surfaces of the) dental article can be customized in shape and hardened.

In one embodiment, the preformed dental article is substantially tooth-shaped at gingival and subgingival exterior surfaces.

In another embodiment, the preformed dental article lacks tooth-shaped supragingival exterior surfaces.

In another embodiment, the preformed dental article comprises tooth-shaped supragingival exterior surfaces and comprises a cavity having a certain cavity volume, the cavity volume dependent on the type of tooth (e.g. molar, premolar, anterior crown).

In another embodiment, the preformed dental article comprises a cavity wherein the preformed dental article has a thickness between the cavity and apical gingival exterior surface of at least 1 mm.

The reduced cavity volume and increased thickness between the cavity and gingival exterior surface are amenable to providing sufficient mass for customizing (e.g. gingival and/or subgingival exterior surfaces) in shape for managing the shape of the healing dental tissue.

In other embodiment, kits are described comprising a plurality of any of the preformed dental articles described herein, optionally in combination with other dental articles (e.g. implant abutments) employed during a tooth implant procedure.

### DETAILED DESCRIPTION

Presently described are methods of affixing a dental article to a tooth implant and preformed dental articles (e.g. suitable for tooth implants) including kits. As used herein, “dental article” refers to any structure suitable to be affixed to an implant abutment or anchor. In some embodiments, the dental article lacks supragingival exterior (i.e. external) surfaces and may be characterized as a healing cap. In other embodiments, the dental article comprises supragingival exterior (i.e. external) surfaces and may be characterized as a (e.g. temporary or provisional) crown.

In one embodiment, a method of affixing a dental article to a tooth implant is described. The method generally comprises providing a preformed (e.g. temporary) dental article and affixing the dental article to an implant abutment or anchor. The preformed temporary dental article is formed from a self-supporting material with sufficient malleability to be subsequently customized in shape and then hardened, such as described in US 2003/0114553; incorporated herein by reference.

As known in the art, the gingival sulcus is bound by the enamel of the crown of a tooth and the sulcular gingival epithelium. The junctional epithelium attaches to the surface of the tooth with hemideosomes and lies immediately apical to the sulcular epithelium. The sulcular epithelium lines the gingival sulcus from the base to the free gingival margin, wherein it interfaces with the epithelium of the oral cavity. Damage to the junctional epithelium can result in this tissue having an irregular rather than smooth texture thereby forming a “pocket”, a primary symptom of gum disease.

Accordingly, to avoid damaging the junctional epithelium, restorative crowns are generally affixed to a natural tooth surface or healed implant abutment such that the exterior (i.e. external) surfaces of the crown contact the sulcular gingival tissue, but not the junctional epithelium.

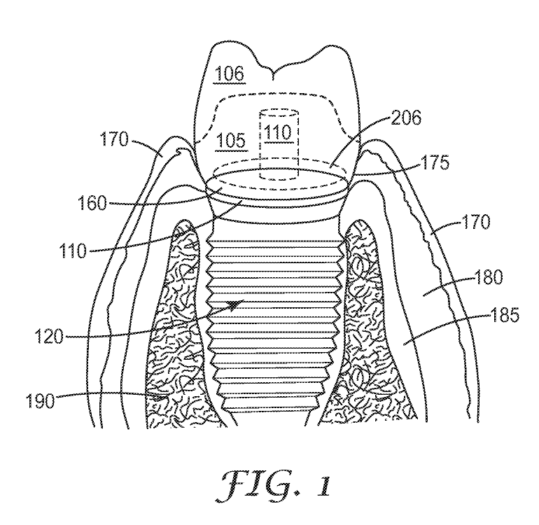

FIG. 1 depicts a perspective view of an embodied preformed dental article affixed to an implant abutment and a cross-sectional view of the adjacent dental tissue. FIG. 1 is representative of affixing a preformed dental article (e.g. immediately) after extraction of a tooth and prior to healing of the gingival and internal tissue. The method described herein comprises affixing a preformed dental article 105 to an implant abutment 110 such that exterior surfaces of the dental article contact sulcular gingival epithelium tissue 170 and internal tissue beneath (e.g. covered or concealed by) the gingival tissue. The internal tissue contacting the exterior surface of the dental article may include the junctional epithelium 175. Typically, however, the junctional epithelium may also be removed during the tooth extraction. More typically, the dental article is in contact with connective tissue 180 which is disposed between the gingival tissue 170 and jaw bone tissue 190. The internal tissue(s) in contact with the dental article are typically above the cortical plate 185. It is appreciated that the specific type of tissue in contact with the exterior surfaces of the dental article may change as a result of the healing process. Nonetheless, the dental article is in contact with internal dental tissue beneath the gingival tissue.

The method further comprises shaping at least a portion of the dental article contacting the gingival tissue 170 or internal (e.g. connective 180) tissue and hardening the dental article. By use of a dental article comprised of a sufficiently malleable material, the dental article can be subsequently customized in shape. Typically, such shaping occurs under a moderate force (i.e., a force that ranges from light finger pressure to that applied with manual operation of a small hand tool, such as a dental composite instrument). The preformed shape in combination with the customization thereof can manage the shape of at least the gingival tissue during the healing of the implant. When the preformed dental article is comprised of a sufficiently malleable material, as described herein, the dental article can be optimized in shape such that the optimized shape obstructs the recession of the gingival tissue and guides the gingival tissue to heal in a shape substantially the same as the natural emergence profile. Doing so can eliminate the need for tissue adjustment via electro surgery or scalpel as well as prevent blanching and impingement of soft tissue at the final restoration stage. At the time of a tooth extraction, the sufficiently malleable material can be optimized in shape to conform to the shape of the resulting socket. However, when a dental implant procedure to replace a tooth that has been missing for sufficient time that the gum tissue has already recessed or begun to recess, the sufficiently malleable material can be used in combination with surgical procedures to recreate the natural emergence profile of the surrounding gum tissue.

The shaping of the dental article typically occurs prior to affixing the dental article to the implant abutment. However, the dental article can alternatively or additionally be shaped after affixing the dental article to the implant abutment, yet prior to hardening (e.g. by photocuring). Further, the dental article can be affixed to the implant abutment either intraorally (i.e. inside the mouth) or extraorally (i.e. outside the mouth), prior to attachment of implant abutment to the anchor. In this later embodiment, the dental article preferably comprises a cylindrical or conical shaped cavity to provide access for attaching the dental abutment to the underlying implant anchor with a screw.

After the dental article has been affixed, shaped, and hardened, the method further comprises allowing the gingival tissues to heal. Once the anchor 120 of the implant has osseointegrated into the jaw bone, which typically takes 2 to 6 months, the temporary dental article is typically replaced with a permanent restoration such as a permanent crown or bridge, as known in the art.

The method described herein can also be employed with a two-step implant method. As known in the art, the two-step method entails suturing the skin over the head of the implant in the area of the implant wound after surgery to allow for healing of the patient's jawbone and gumline. Once the implant has osteointegrated into the jaw bone, the healed dental tissue above the tooth implant is surgically removed in order to expose the head of the implant for receipt of a temporary or permanent crown. Accordingly, when the two-step method is employed, the method further comprises removing (healed) dental tissue above the tooth implant abutment or anchor such that gingival tissue, internal tissue, and the tooth implant abutment or anchor are exposed prior to affixing the dental article.

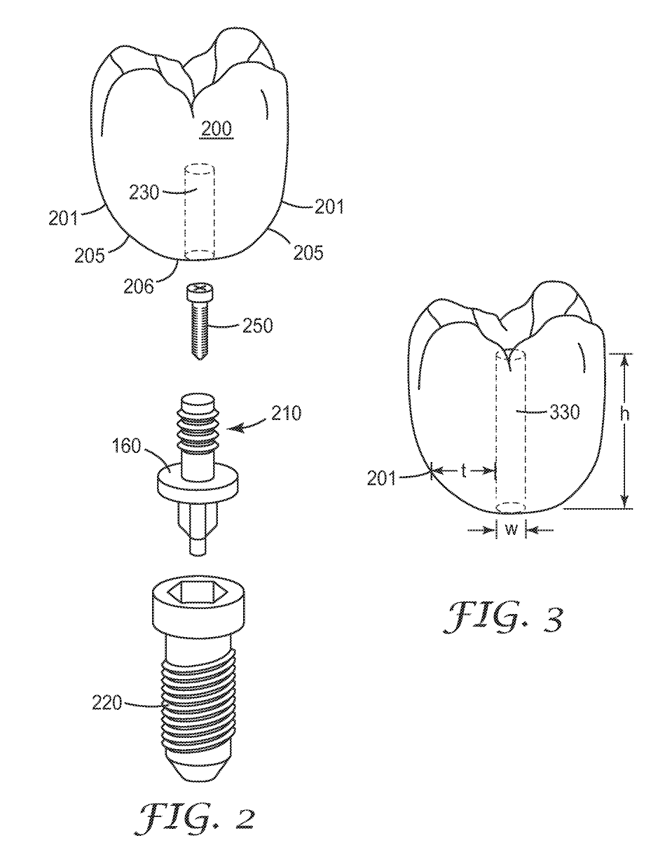

With reference to FIG. 2, the dental article 200 preferably comprises substantially tooth-shaped gingival exterior surfaces 201. “Gingival exterior surface” refers to the exterior surfaces that will come in contact with the gingival tissue. The dental article 200 also preferably comprises substantially tooth-shaped subgingival exterior surfaces 205. “Subgingival exterior surface” refers to the exterior surfaces between the base and gingival exterior surfaces that will come in contact with internal (e.g. connective) tissue beneath the gum line.

The preformed dental article preferably comprises a convex gingival exterior surface 201. Particularly for molar implants, the dental article further comprises a convex subgingival exterior surface 205. Hence, the exterior surface of the dental article may be continuously convex from the gingival exterior surface to the substantially planar base exterior surface that contacts the implant (e.g. abutment) platform (i.e. 160 of FIG. 1). Although the radius of curvature of this convex surface can vary, the radius of curvature is typically at least 2 mm and no greater than 10 mm. Alternatively, such as in the case of incisors the subgingival exterior surfaces of the dental article may comprise a slight concavity (not shown).

In some embodiments, such as depicted by the FIGS. 2-3, the dental article comprises substantially tooth-shaped exterior surfaces both below and above the gum line. For example, the shape may take the form of a natural maxillary or mandibular tooth, including anterior crowns (i.e. central incisor, lateral incisor, canine), premolar, or molar tooth. This can be accomplished by preforming the dental article such that the exterior surfaces of the dental article comprise both subgingival and supragingival tooth-shaped exterior surfaces.

In other embodiments, such as depicted by the dental article 105 outlined by the dashed lines of FIG. 1, the (e.g. temporary) dental article may be predominantly a healing cap. The supragingival exterior surfaces substantially lack a tooth-shaped structure. A crown 106 having substantially tooth-shaped supragingival exterior surfaces can be affixed to the dental article 105.

The dental article can be affixed to the implant abutment or dental article 105 with a dental cement as known in the art. Typically, the cavity 230 and 330 of the dental article is partially filled with a dental cement and then placed over the implant abutment such that the base of the dental article contacts the abutment platform 160. A temporary dental cement is typically used for embodiments wherein the dental article is affixed temporality, such as for embodiments wherein the dental article functions as a healing cap, lacking tooth-shaped supragingival exterior surfaces. Suitable temporary cements are commercially available such as available from 3M ESPE under the trade designation “RelyX Temp NE Temporary Cement”. A permanent dental cement, such as commercially available from 3M ESPE under the trade designation “RelyX Unicem Self Adhesive Universal Resin Cement”, is employed for embodiments wherein the dental article is a permanent dental article, such as when the dental article functions as a permanent restoration, having tooth-shaped supragingival exterior surfaces.

When the dental article is also substantially tooth-shaped above the gum line, the dental article may serve as a permanent rather than temporary restoration.

Also described are preformed (e.g. temporary) dental articles. The dental articles are sufficiently malleable such that the preformed article can be customized in shape and hardened. In preferred embodiments, as depicted in FIGS. 1-3 and previously described, the preformed dental article comprises substantially tooth-shaped gingival and subgingival exterior surfaces, i.e. at least where the dental article contacts the gingival tissue and internal (e.g. connective) tissue beneath the gingival tissue.

As illustrated by FIGS. 2-3, when the dental articles are intended for use with implants, the preformed articles comprise an interior cavity 230 and 330, suitably sized and shaped for receipt of an implant abutment. Although various designs of implant abutments are known in the art, when the interior cavity is substantially conical or cylindrical in shape, the cavity can accommodate a wide variety of implant designs.

The dental article is preferably universal in fit for various commercially available abutment systems such as available from Straumanns, 3I, Astra tech, Zimmer, and Nobel. The dental article may be designed to accommodate various regular and wide neck abutments as well as synthetic temporary abutments. The dental article may be employed for the purpose of attachment to temporary abutment cylinders as well as permanent abutments, optionally customized to many shapes and sizes.

Any gap created by a mismatch in size and/or shape between the cavity of the dental article and the abutment can be filled with a dental material such as a flowable composite or dental cement, as known in the art, at the time the dental article is affixed to the implant abutment. Alternatively, the cavity of the dental article can be sized and shaped to provide a custom fit between the dental article and the dental implant abutment.

With reference to FIG. 3, the width (“w”) of the cavity at the base of the dental article typically ranges from about 2 mm to about 6 mm, (e.g., 2.5 mm, 3.3 mm, 3.5 mm, 4.0 mm, 4.1 mm, 4.3 mm, 4.8 mm, 5.0 mm, 6.0 mm etc.) Suitable heights (“h”) for such cavity may be configured to match known implant abutment heights. Typically, the height is at least about 10 mm and no greater than about 20 mm.

In one embodiment, the thickness (“t”) of the dental article between the cavity and apical (i.e. highest point relative to the base) gingival exterior surface 201 is preferably at least 1 mm (except in the case of a lower incisor or lower lateral). When the dental article comprises a convex gingival surface, the apical gingival exterior surface may be characterized by the onset of curvature. In some embodiments, the thickness (“t”) may be at least 1.1, 1.2, 1.3, or 1.4 mm. In the case of premolars, the thickness is typically at least 1.50 mm. In some embodiments, the thickness (“t”) may be at least 1.6, 1.7, 1.8, or 1.9 mm. For molars, this thickness is typically at least 2, 2.5, or 3 mm.

In one embodiment, the preformed dental article (e.g. suitable for use as a healing cap) lacks tooth-shaped supragingival exterior surfaces.

When the preformed dental article is also tooth-shaped supragingivally, the volume of the cavity can vary depending on the type of tooth. For example, when the dental article is a molar, the cavity typically has a volume of less than 45% of the total volume of the dental article and the cavity. For premolars, such cavity volume is typically less than 36%. In the case of anterior crowns (i.e. canines and incisors), the cavity typically has a volume of less than 42% of the total volume of the dental article and the cavity. Such cavity volume can be less than 33% for incisors.

In other embodiments, kits are described comprising a single preformed dental articles or a plurality of preformed dental articles. The implant dental articles may correspond in size and shape to natural teeth selected from the group consisting of maxillary and mandibular central incisors, lateral incisors, canines, premolars, and molar teeth. The kit may comprise implant dental articles of more than one shade of tooth color, in order to select a dental article that closely matches the patient's natural teeth. The kit may further include or be combined with other article employed during a tooth implant procedure such as an implant abutment or anchor.

Various dental implant systems, as known in the art, may be used in combination with the method and dental article described herein. With reference to FIGS. 1-2, dental implant systems generally include a (e.g. cylindrical) anchor 120 and 220 that is implanted in the patients jawbone. The dental implant system also includes a temporary or permanent abutment that 110 and 210 that mates with the anchor and extends at least slightly above the gum line.

Various suitable abutments, as known in the art may be used in connection with the method and dental articles described herein.

Abutments may be made with a variety of materials including metals, (e.g. palladium-silver alloy, stainless steel, aluminum, titanium gold etc.), plastic materials (e.g. acrylics) including plastics that further comprise an inorganic filler; and ceramic materials such as those comprising zirconia and aluminum oxide, etc.).

The abutment may take the form of an elongated tubular body which has a base portion adapted at a first end of the body to mate with the gingival aspect of the implant anchor, and a solid or thin-walled tubular portion extending to the other end of the body supragingivally from the base portion when the base portion is so mated. In one embodiment, the abutment comprises a shoulder (not shown) within the cavity for cooperation with a screw 250 to fasten the abutment to the implant anchor. Exemplary abutments that include a collar are commercially available from Nobel Biocare under the trade designation “Easy Abutment”.

Alternatively, the abutment may lack a collar. In such embodiment, the base of the dental article may rest directly on the implant anchor. Exemplary abutments that lack a collar are commercially available from Straumann ITI.

Abutments comprising external threads to mate with internal threads of the implant anchor have also been described in the art.

The preformed (e.g. temporary) dental articles are prepared from a hardenable material that can be customized in shape to specifically mate to the gingival and/or internal tissue beneath the gingival tissue. The preformed dental articles (of a first shape) are preferably prepared from a hardenable self-supporting resin system with sufficient malleability to be subsequently customized into a second shape.

Herein, the “resin system” can include one or more resins, each of which can include one or more monomers, oligomers, and/or polymerizable polymers.

The term “self-supporting” means that the composition is dimensionally stable and will maintain its shape (e.g., preformed shape of a cap) without significant deformation at room temperature (i.e., about 20° C. to about 25° C.) for at least about two weeks when free-standing (i.e., without the support of packaging or a container). Preferably, the compositions are dimensionally stable at room temperature for at least about one month, and more preferably, for at least about six months. Preferably, the compositions are dimensionally stable at temperatures above room temperature, more preferably up to about 40° C., even more preferably up to about 50° C., and even more preferably up to about 60° C. This definition applies in the absence of conditions that activate the initiator system and in the absence of an external force other than gravity.

The term “sufficient malleability” means that the self-supporting structure is capable of being custom shaped and fitted, for example, to a patient's mouth, under a moderate force (i.e., a force that ranges from light finger pressure to that applied with manual operation of a small hand tool, such as a dental composite instrument). In some embodiments, the self-supporting preformed dental article has sufficient malleability to be reformed into a second shape at temperature of 40° C. of less. In some preferred embodiments, the hardenable composition exhibits “sufficient malleability” at a temperature of about 15° C. to 38° C., a temperature of about 20° C. to 38° C., or at room temperature.

In many embodiments, the hardenable compositions of the preformed dental articles described herein are “irreversibly hardenable” which, as used herein, means that after hardening such that the composition loses its malleability it cannot be converted back into a malleable form without destroying the external shape of the dental article. Examples of some potentially suitable hardenable compositions that may be used to construct the preformed dental article described herein with sufficient malleability may include, e.g., hardenable organic compositions (filled or unfilled), polymerizable dental waxes, hardenable dental compositions having a wax-like or clay-like consistency in the unhardened state, etc. In some embodiments, the preformed dental articles are constructed of hardenable compositions that consist essentially of non-metallic materials.

Suitable hardenable compositions that may be used to manufacture the preformed dental articles are described in U.S. Patent Application Publication No. US 2003/0114553, titled HARDENABLE SELF-SUPPORTING STRUCTURES AND METHODS (Karim et al.). Other suitable hardenable compositions may include those described in U.S. Pat. Nos. 5,403,188 (Oxman et al.); 6,057,383 (Volkel et al.); and 6,799,969 (Sun et al.); each incorporated herein by reference.

Organogelators described in WO2008/033911, incorporated herein by reference, can be utilized in combination with the hardenable compositions and/or interior materials in the dental articles described herein. These organgelator compositions can be flowable, packable, or self-supporting. The term “organogelator” means a low molecular weight compound (generally no greater than 3000 grams per mole) that forms a three-dimensional network structure when dissolved in an organic fluid, thereby immobilizing the organic fluid and forming a non-flowable thermally-reversible gel. In some embodiments the organogelator is a urea-type organogelator, a sugar-based compound, or a mixture thereof. Suitable sugar-based compounds include amino sugar organogelator, dibenzylidene sorbitol, alpha-manno(methyl 4,6,-O-benzylidene-alpha-D-mannopyranoside, or a mixture thereof.

In some embodiments, the hardenable self-supporting compositions have rheological properties similar to waxes below the waxes' melting points in that they can be relatively easily deformed (i.e., they are malleable) and exhibit low elastic recovery. The compositions are typically not free-flowing fluids (i.e., liquids) above their softening points. That is, the compositions can display appreciable mass flow under moderate (e.g., hand) pressure, but not liquid flow above their softening points.

Typically, elastic and viscous dynamic moduli of the hardenable compositions vary over a wide range. Furthermore, the hardenable compositions are typically largely free from tack. Preferably, the elastic dynamic modulus (i.e., elastic modulus) G′ is at least about 100 kilopascals (kPa), more preferably, at least about 200 kPa, and most preferably, at least about 1000 kPa, at a frequency of about 0.005 Hz. Preferably, the elastic modulus G′ is no greater than about 50,000 kPa, more preferably, no greater than about 10,000 kPa, and most preferably, no greater than about 5000 kPa, at a frequency of about 0.005 Hz. Preferably, the viscous dynamic modulus (i.e., viscous modulus) G″ is at least about 50 kPa, more preferably, at least about 200 kPa, and most preferably, at least about 1000 kPa, at a frequency of about 0.005 Hz. Preferably, the viscous modulus G″ is no greater than about 50,000 kPa, more preferably, no greater than about 10,000 kPa, and most preferably, no greater than about 5000 kPa, at a frequency of about 0.005 Hz.

The desired self-supporting (i.e., free-standing) structure of the hardenable compositions can typically be maintained by creating a morphology that includes a noncovalent structure, which may be a three-dimensional network (continuous or discontinuous) structure. This can result from the use of a crystalline component in the resin system, or the use of one or more fillers, typically aided by one or more surfactants, or the use of both a crystalline component and one or more fillers optionally combined with one or more surfactants. These components are discussed in more detail below.

With the appropriate initiator system, e.g., a free radical photoinitiator, the hardenable compositions can be hardened (e.g., cured) to form the desired product. Preferably, the resultant hardened composition (i.e., the hardened structure) has a flexural strength of at least about 25 megapascals (MPa), more preferably, at least about 40 MPa, even more preferably, at least about 50 MPa, and most preferably, at least about 60 MPa.

In some embodiments, the resultant hardened composition is an enamel-like solid, preferably having a compressive strength of at least about 100 MPa and/or a diametral tensile strength of at least about 20 MPa and/or a flexural modulus of at least about 1000 MPa.

The resin system includes one or more hardenable organic resins capable of forming a hardened material having sufficient strength and hydrolytic stability to render them suitable for use in the oral environment.

As used herein, a resin includes one or more monomers, oligomers, and/or polymerizable polymers, including combinations thereof. Although, in this context oligomers and polymers are both used, the terms “polymer” and “polymeric” are used herein to refer to any materials having 2 or more repeat units, thereby encompassing oligomers. Thus, unless otherwise specified, polymers include oligomers. Furthermore, the term polymer is used herein to encompass both homopolymers and copolymers, and the term copolymer is used herein to encompass materials with two or more different repeat units (e.g., copolymers, terpolymers, tetrapolymers)

A preferred organic resin is hardenable (e.g., polymerizable and/or crosslinkable), preferably by a free radical mechanism, and includes monomers, oligomers, and/or polymers. The resin system includes a reactive component (i.e., a component capable of polymerizing and/or crosslinking), which may or may not be crystalline. Resin systems that include noncrystalline reactive components may optionally include a crystalline component, which may or may not be reactive.

Preferably, at least some of the resin components include ethylenic unsaturation and are capable of undergoing addition polymerization. A suitable resin preferably includes at least one ethylenically unsaturated monomer (i.e., includes at least one carbon-carbon double bond).

Examples of suitable polymerizable resin components include: mono-, di-, or poly-(meth)acrylates (including acrylates and methacrylates) such as methyl acrylate, methyl methacrylate, ethyl acrylate, isopropyl methacrylate, n-hexyl acrylate, stearyl acrylate, allyl acrylate, glycerol mono- and diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis(1-(2-acryloxy))-p-ethoxyphen-yldimethylmethane, bis(1-(3-acryloxy-2-hydroxy))-p-propoxyphenyldimethylme-thane, tris(hydroxyethylisocyanurate) trimethacrylate, 2-hydroxyethyl methacrylate, 2-hydroxypropyl methacrylate, tetrahydrofurfuryl methacrylate, ethylene glycol dimetliacrylate, triethylene glycol dimethacrylate, bisGMA, ethoxylated bisphenolA diacrylate, ethoxylated bisphenolA dimethacrylate, biphenyl monomers such as described in Provisional Patent Application No. 61/094,211, filed Sep. 4, 2008 and Provisional Patent Application No. 61/107,400, filed Oct. 22, 2008 polyethylene glycol dimethacrylate, the bis-acrylates and bis-methacrylates of polyethylene glycols of molecular weight 200-500, copolymerizable mixtures of acrylated monomers such as those of U.S. Pat. No. 4,652,274 (Boettcher et al.), and acrylated oligomers such as those of U.S. Pat. No. 4,642,126 (Zador); unsaturated amides such as (meth)acrylamides (i.e., acrylamides and methacrylamides), methylene bis-acrylamide, methylene bis-methacrylamide, 1,6-hexamethylene bis-acrylamide, diethylene triamine tris-acrylamide, and beta-methacrylamidoethyl methacrylate, diacetone acrylamide, and diacetone methacrylamide; urethane (meth)acrylates; and vinyl compounds such as styrene, diallyl phthalate, divinyl succinate, divinyl adipate, and divinylphthalate. Mixtures of two or more such materials can be used if desired in the resin system.

Preferably, the total amount of the resin system is at least about 10 wt-%, more preferably, at least about 13 wt-%, and most preferably, at least about 15 wt-%, based on the total weight of the composition. Preferably, the total amount of the resin system is no greater than about 60 wt-%, more preferably, no greater than about 50 wt-%, and most preferably, no greater than about 40 wt-%, based on the total weight of the composition.

The above-listed components are typically noncrystalline (i.e., amorphous).

In some embodiments, the resin system can also include a crystalline component to impart the noncovalent three-dimensional structure for maintaining the initial preformed shape such as described in US 2003/0114553; incorporated herein by reference. This crystalline component may or may not have a reactive group capable of polymerizing (also including crosslinking) Preferably, the crystalline component is polymerizable. Preferably, the crystalline component is polymeric (including oligomeric). More preferably, the crystalline component is a polymerizable polymeric material.

By “crystalline” it is meant that the material displays a crystalline melting point at 20° C. or above when measured in the composition by differential scanning calorimetry (DSC). The peak temperature of the observed endotherm is taken as the crystalline melting point. The crystalline phase includes multiple lattices in which the material assumes a conformation in which there is a highly ordered registry in adjacent chemical moieties of which the material is constructed. The packing arrangement (short order orientation) within the lattice is highly regular in both its chemical and geometric aspects.

The crystalline resin component includes at least one material that crystallizes, preferably above room temperature (i.e., 20° C. to 25° C.). Such crystallinity, that may be provided by the aggregation of crystallizable moieties present in the component (e.g., when the component is a polymer, in the backbone (i.e., main chain) or pendant substituents (i.e., side chains) of the component), can be determined by well known crystallographic, calorimetric, or dynamic/mechanical methods. This component imparts to the resin system at least one melting temperature (Tₘ) as measured experimentally (for example by DSC) of greater than about 20° C. Preferably, this component imparts a T.sub.m to the resin system of about 30° C.-100° C. If more than one crystalline material is used in the crystalline component, more than one distinct melting point may be seen.

Examples of suitable crystalline materials having crystallizable main chain or backbone segments include, but are not limited to, polyesters (including polycaprolactones), polyethers, polythioethers, polyarylalkylenes, polysilanes, polyamides, polyolefins (preferably, formed from lower, e.g., C₂-C₃, olefins), and polyurethanes.

Preferred crystalline materials are saturated, linear, aliphatic polyester polyols (particularly diols) containing primary hydroxyl end groups. Examples of commercially available materials useful as the crystalline resin component include some resins available under the trade designation LEXOREZ from Inolex Chemical Co., Philadelphia, Pa. Examples of other polyester polyols are those available under the trade designation RUCOFLEX from Ruco Polymer Corp., Hicksville, N.Y. Examples of polycaprolactones include those available under the trade designations TONE 0230, TONE 0240, and TONE 0260 from Dow Chemical Co., Midland, Mich. Especially preferred materials are saturated, linear, aliphatic polyester polyols that are modified (e.g., through primary hydroxyl end groups) to introduce polymerizable, unsaturated functional groups, e.g., polycaprolactone diol reacted with 2-isocyanatoethyl methacrylate, methacryloyl chloride, or methacrylic anhydride.

Examples of suitable crystalline polymeric materials having crystallizable pendant moieties (i.e., side chains) include, but are not limited to polymeric materials having the following general formula:

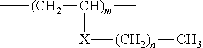

wherein R is hydrogen or a (C₁-C₄)alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer, and n is great enough to provide sufficient side chain length and conformation to form polymers containing crystalline domains or regions. Preferably, m is at least 2, and more preferably, 2 to 100, and preferably, n is at least 10. The crystalline polymeric materials may be prepared by the polymerization of monomers containing the pendant (side chain) crystallizable moieties or by the introduction of pendant crystallizable moieties by chemical modification of a polyacrylate, polymethacrylate, polyacrylamide, polymethacrylamide, polyvinyl ester, or poly-alpha-olefin polymers or copolymers. The preparation and morphology/conformational properties that determine the crystalline character of such side chain crystallizable or “comb-like” polymers are reviewed by Plate and Shibaev, “Comb-Like Polymers. Structure and Properties,” Journal of Polymer Science, Macromolecular Reviews, 8, 117-253 (1974).

Another crystalline component includes compounds of the formula:

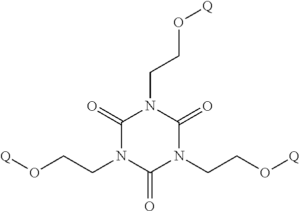

wherein each Q independently includes polyester segments, polyamide segments, polyurethane segments, polyether segments, or combinations thereof. Preferably, each Q independently includes poly(caprolactone) segments. More preferably, such crystalline compounds include polymerizable groups, such as epoxy, acid, alcohol, and ethylenically unsaturated reactive sites. Particularly preferred such materials include unsaturated polymerizable groups, such as methacrylic, acrylic, vinyl, and styryl groups.

Fillers for use in the filler system may be selected from a wide variety of conventional fillers for incorporation into resin systems. Preferably, the filler system includes one or more conventional materials suitable for incorporation in compositions used for medical applications, for example, fillers currently used in dental restoration compositions. Thus, the filler systems used in the compositions are incorporated into the resin systems, and particularly mixed with the crystalline component of the resin system.

Fillers may be either particulate or fibrous in nature. Particulate fillers may generally be defined as having a length to width ratio, or aspect ratio, of 20:1 or less, and more commonly 10:1 or less. Fibers can be defined as having aspect ratios greater than 20:1, or more commonly greater than 100:1. The shape of the particles can vary, ranging from spherical to ellipsoidal, or more planar such as flakes or discs. The macroscopic properties can be highly dependent on the shape of the filler particles, in particular the uniformity of the shape.

Preferred particulate filler is finely divided and has an average particle size (preferably, diameter) of less than about 10 micrometers (i.e., microns). Preferred micron-size particulate filler has an average particle size of at least about 0.2 microns up to 1 micrometers. Nanoscopic particles have an average primary particle size of less than 200 nm (0.2 microns). The filler can have a unimodal or polymodal (e.g., bimodal) particle size distribution.

Micron-size particles are very effective for improving post-cure wear properties. In contrast, nanoscopic fillers are commonly used as viscosity and thixotropy modifiers. Due to their small size, high surface area, and associated hydrogen bonding, these materials are known to assemble into aggregated networks. Materials of this type (“nanoscopic” materials) have average primary particle sizes (i.e., the largest dimension, e.g., diameter, of unaggregated material) of no greater than about 1000 nanometers (nm). Preferably, the nanoscopic particulate material has an average primary particle size of at least about 2 nanometers (nm), and preferably at least about 7 nm. Preferably, the nanoscopic particulate material has an average primary particle size of no greater than about 50 nm, and more preferably no greater than about 20 nm in size. The average surface area of such a filler is preferably at least about 20 square meters per gram (m²/g), more preferably, at least about 50 m²/g, and most preferably, at least about 100 m²/g.

The filler can be an inorganic material. It can also be a crosslinked organic material that is insoluble in the polymerizable resin, and is optionally filled with inorganic filler. The filler is preferably generally non-toxic and suitable for use in the mouth. The filler can be radiopaque, radiolucent, or nonradiopaque. Fillers as used in dental applications are typically ceramic in nature.

Examples of suitable inorganic fillers are naturally occurring or synthetic materials such as quartz, nitrides (e.g., silicon nitride), glasses derived from, for example Ce, Sb, Sn, Zr, Sr, Ba, or Al, colloidal silica, feldspar, borosilicate glass, kaolin, talc, titania, and zinc glass, zirconia-silica fillers; and low Mohs hardness fillers such as those described in U.S. Pat. No. 4,695,251 (Randklev).

Examples of suitable organic filler particles include filled or unfilled pulverized polycarbonates, polyepoxides, and the like. Preferred filler particles are quartz, submicron silica, and non-vitreous microparticles of the type described in U.S. Pat. No. 4,503,169 (Randklev). Mixtures of these fillers can also be used, as well as combination fillers made from organic and inorganic materials.

Optionally, the surface of the filler particles may be treated with a surface treatment, such as a silane-coupling agent, in order to enhance the bond between the filler and the resin system. The coupling agent may be functionalized with reactive curing groups, such as acrylates, methacrylates, and the like.

The filler particles used to impart a noncovalent structure can be composed of silica, alumina, zirconia, titania, or mixtures of these materials with each other or with carbon. In their synthesized state, these materials are commonly hydrophilic, due to the presence of surface hydroxyl groups. However, the materials may also be modified by treatment with appropriate agents, such as alkyl silanes, in order to modify this character. For example, the surface of a filler particle may be rendered neutral, hydrophobic, or reactive, depending on the desired properties. Fumed silica is a preferred compound for imparting self-supporting character, due to its low cost, commercial availability, and wide range of available surface character.

Preferably, the total amount of filler system is greater than 50 wt-%, more preferably, greater than 60 wt-%, and most preferably, greater than 70 wt-%, based on the total weight of the composition. If the filler system includes fibers, the fibers are present in an amount of less than 20 wt-%, based on the total weight of the composition. Preferably, the total amount of filler system is no more than about 95 wt-%, and more preferably, no more than about 80 wt-%, based on the total weight of the composition.

The compositions also contain an initiator system, i.e., one initiator or a mixture of two or more initiators, which are suitable for hardening (e.g., polymerizing and/or crosslinking) of the resin system. Various suitable initiator systems are known in the art, such as described in US2003/0114553.

The initiators are preferably free radical initiators, which may be activated in a variety of ways, e.g., heat and/or radiation. Thus, for example, the initiator system can be a thermal initiator system (e.g., azo compounds and peroxides), or a photoinitiator system. Preferably, the initiator system includes one or more photoinitiators. More preferably, the initiator system includes at least one photoinitiator active in the spectral region of about 300 nanometers (nm) to about 1200 nm and capable of promoting free radical polymerization and/or crosslinking of ethylenically unsaturated moieties upon exposure to light of suitable wavelength and intensity. A wide variety of such photoinitiators can be used. The photoinitiator preferably is soluble in the resin system. Preferably, they are sufficiently shelf stable and free of undesirable coloration to permit storage and use under typical dental operatory and laboratory conditions. Visible light photoinitiators are preferred.

Preferred visible light-induced initiators include camphorquinone combined with a suitable hydrogen donor (e.g., an amine such as those described above for the first initiator system), and optionally a diaryliodonium simple or metal complex salt, chromophore-substituted halomethyl-s-triazine, or halomethyl oxadiazole. Particularly preferred visible light-induced photoinitiators include combinations of an alpha-diketone, e.g., camphorquinone with additional hydrogen donors, and optionally a diaryliodonium salt, e.g., diphenyliodonium chloride, bromide, iodide or hexafluorophosphate.

Preferred ultraviolet light-induced polymerization initiators include ketones, such as benzyl and benzoin, acyloins, and acyloin ethers. Preferred ultraviolet light-induced polymerization initiators include 2,2-dimethoxy-2-phenylacetophenone available under the trade designation IRGACURE 651 and benzoin methyl ether (2-methoxy-2-phenylacetophenone), both from Ciba Speciality Chemicals Corp., Tarrytown, N.Y.

The initiator system is present in an amount sufficient to provide the desired rate of hardening (e.g., polymerizing and/or crosslinking) For a photoinitiator, this amount will be dependent in part on the light source, the thickness of the layer to be exposed to radiant energy, and the extinction coefficient of the photoinitiator. Preferably, the initiator system is present in a total amount of at least about 0.01 wt-%, more preferably, at least about 0.03 wt-%, and most preferably, at least about 0.05 wt-%, based on the weight of the composition. Preferably, the initiator system is present in a total amount of no more than about 10 wt-%, more preferably, no more than about 5 wt-%, and most preferably, no more than about 2.5 wt-%, based on the weight of the composition.

The compositions may contain a surfactant system, i.e., one surfactant or a mixture of two or more surfactants. These surfactants, when used in small amounts may interact with other components of the composition, such as an inorganic filler material, to enhance the formation of a noncovalent three-dimensional structure. Such surfactants can be nonionic, anionic, or cationic, as described in US 2003/0114553. The surfactant(s) can be copolymerizable with the resin system or non-copolymerizable. A consideration in the choice of a surfactant that can be used is the degree to which the ingredients of the system are able to participate in hydrogen bonding.

Preferably, the total amount of surfactant system is at least about 0.05 wt-%, more preferably, at least about 0.1 wt-%, and most preferably, at least about 0.2 wt-%, based on the total weight of the composition. Preferably, the total amount of surfactant system is no more than about 5.0 wt-%, more preferably, no more than about 2.5 wt-%, and most preferably, no more than about 1.5 wt-%, based on the total weight of the composition.

The composition may additionally include optional agents such as colorants (e.g., pigments conventionally used for shade adjustment), flavorants, stabilizers (such as BHT), viscosity modifiers, and the like. Such agents may optionally include reactive functionality so that they will be copolymerized with the resin.

The compositions can be shaped (e.g., molded) into a variety of forms like three-dimensional shapes, preformed sheets, arch-shaped trays, ropes, buttons, woven, or non-woven webs, and the like. The composition can be shaped (to form a first shape) in a variety of ways including, for example, extruding, injection molding, compression molding, thermoforming, vacuum forming, and pressing. Typically, a semi-finished shape is formed using a mold with a positive and negative impression.

In some embodiments, the shaped articles consist solely of the (e.g. self-supporting) sufficiently malleable material as described herein. In other embodiments, only the external portion (e.g. the contacts the gingival tissue or internal tissue beneath the gingival tissue) that is intended to be customized in shape for tissue management comprises the (e.g. self-supporting) sufficiently malleable material as described herein. For example, the dental article may comprise a different interior material such as described in WO 2008/033893; incorporated herein by reference. In one embodiment, the dental articles comprise an external layer formed of a self-supporting hardenable preformed material, the external layer having a dental article shape defined by an external layer surface, the external layer defining an interior volume; and an interior material disposed within the interior volume, wherein the interior material is different than the external hardenable preformed material and the interior material has a yield stress value of 100 dyn/cm² or greater. Such preformed multilayer dental articles may have two or more layers of material to allow for accurate fit to the dental implant abutment. Further, multilayer dental articles can provide better esthetics, particularly for embodiments wherein the dental article comprises tooth-shaped supragingival exterior surfaces e.g., by having a multi-chromatic appearance. Additionally such multilayer dental articles can provide a better overall balance of mechanical properties, as well as improved customization, including a more accurate fit to dental preparations.

The shaped articles can be sold individually or in multiple units, preferably packaged in a way that protects them from heat and/or light that can activate the initiator system contained in the composition.

Generally, a preformed article of appropriate size and shape (the first shape) is selected and custom shaped at a temperature of about 15° C. to 38° C. (preferably, about 20° C. to 38° C., which encompasses typical room temperatures and body temperatures, and more preferably, at room temperature). This shaping can be done by a variety of methods including applying pressure with fingers or an instrument of choice (e.g., hand operation of dental composite instrument), trimming, cutting, sculpting, grinding, etc. Once the desired custom shape has been achieved, the article is hardened (e.g., cured) by exposing it to heat/radiation to cause activation of the initiator system. This can be done either in a single step, or in multiple steps with successive steps of custom shaping being done in-between. One or more of these steps can be carried out in an oxygen-free inert atmosphere or in vacuum. After the final shaping and hardening steps, the hardened article can be further modified in shape by grinding, trimming, etc., if desired. Once the final custom shape of the article has been obtained, it can be polished, painted, or otherwise surface treated, if required for the intended application. Preferably, the final custom shaped articles prepared from the compositions do not need an additional veneering material (e.g., a second material that provides a desired appearance or property). The intended application may require mounting, bonding, or otherwise attaching the custom shaped cured article to a second object adhesively, mechanically, or by combination of both.

For the preparation of a dental article, an appropriate shape and size of a preformed dental article is selected and the preformed dental article is seated on the (e.g. temporary) implant abutment to determine the extent of trimming and shaping required, optionally making marks on the cap. The preformed dental article may be removed from the mouth, the required shape and size adjustments are made by cutting, trimming, shaping, etc., and then re-seated on the (e.g. temporary) implant abutment where additional shape adjustments are made to provide optimum custom fit, including at least gingival fit. When the dental article comprises a supragingival tooth-shaped structure the adjustments typically also include lateral and occlusal fit. The preformed and reshaped dental article can then be hardened, typically by exposing it to a dental curing light for a few seconds, if desired, while in the mouth, and then removing it carefully from the mouth and exposing it for final cure to a curing light in a cure chamber, optionally in combination with heat. Additional adjustments can be made by grinding, trimming, etc., if required, and the finished dental article is polished and cleaned. The finished dental article can then be cemented as is or lined with a suitable resin material prior to placement in the mouth.

The hardenable, self-supporting structures implant dental article can be prepackaged either individually or as an ensemble. Such packaging material should protect these products from conditions that would activate the initiator system and thus cause premature hardening, e.g., such as could result from exposure to light in the case of a photoinitiator.

Various methods of manufacturing hardenable dental articles, packaged hardenable dental articles, and methods of packaging hardenable dental articles are known, such as described in US2005/0100868; incorporated herein by reference. One method of manufacturing comprises providing a mold cavity in a shape of a hardenable dental article, wherein the mold cavity comprises an opening; forcing a hardenable dental material into the mold cavity through the opening; providing an outer liner between the hardenable dental material and the mold cavity; and removing the hardenable dental material and the outer liner from the mold cavity. In one embodiment, the method comprises providing the outer liner between the hardenable dental material and the mold cavity comprises deforming the outer liner to form a pocket therein by forcing the hardenable dental material into contact with the outer liner, wherein the hardenable dental material is located within the pocket before forcing the hardenable dental material into the mold cavity. Forcing the hardenable dental material through the opening may comprise forcing a core pin against the hardenable dental material, and a pin liner may be provided between the hardenable dental material and the core pin.

The hardenable dental material typically has the shape of the hardenable dental article. Further, the outer liner releases from the hardenable dental article after or during removal from the mold cavity. The packaged hardenable dental article may comprise a mass of hardenable dental material in the shape of a hardenable dental article, wherein the hardenable dental article comprises a base and outer surfaces extending from the base; and a package cover conforming to the outer surfaces of the hardenable dental article. The package cover comprises a polymeric film plastically deformed by the mass of hardenable dental material. The package cover may include a flange extending away from the hardenable dental article in order to provide a handle for removal of the package cover.

1. A method of affixing a dental article to a tooth implant comprising:
providing a preformed dental article comprised of a sufficiently malleable material such that the preformed dental article can be customized in shape;
shaping at least a portion of the dental article that contacts gingival tissue or internal tissue beneath the gingival tissue;
affixing the dental article to a tooth implant abutment or anchor such that the dental article contacts the gingival tissue and internal tissue; and
hardening the dental article.

2. The method of claim 1 wherein the dental article is affixed after extraction of a tooth and prior to healing of the gingival and internal tissue.

3-19. (canceled)

20. A preformed dental article comprising substantially tooth-shaped gingival and subgingival exterior surfaces; wherein the dental article is sufficiently malleable such that it can be customized in shape and hardened and the dental article comprises a convex gingival exterior surface.

21. (canceled)

22. The preformed dental article of claim 20 wherein the dental article comprises a convex subgingival exterior surface.

23. The preformed dental article of claim 20 wherein the dental article comprises a cavity.

24. The preformed dental article of claim 20 wherein the dental article lacks tooth-shaped supragingival exterior surfaces.

25. The preformed dental article of claim 23 wherein the dental article comprises tooth-shaped supragingival exterior surfaces and is selected from the group consisting of
a) a molar having a cavity volume of less than 45% of the total volume of the dental article and the cavity;
b) a premolar having a cavity volume of less than 36% of the total volume of the dental article and the cavity; and
c) an anterior crown having a cavity volume of less than 42% of the total volume of the dental article and the cavity.

26. The preformed dental article of claim 23 wherein the dental article has a thickness between the cavity and apical gingival exterior surface of at least 1 mm.

27. The preformed dental article of claim 26 wherein the dental article comprises tooth-shaped supragingival exterior surface and is selected from the group consisting of
a) a premolar wherein the thickness is at least 1.50 mm; and
b) a molar wherein the thickness is at least 3 mm.

28. A preformed dental article comprising substantially tooth-shaped gingival and subgingival exterior surfaces and lacking tooth-shaped supragingival exterior surfaces; wherein the dental article is sufficiently malleable such that it can be customized in shape and hardened.

29. (canceled)

30. A preformed dental article comprising a cavity wherein the dental article is sufficiently malleable such that it can be customized in shape and hardened, the preformed dental article has a thickness between the cavity and apical gingival exterior surface of at least 1 mm, and the dental article comprises tooth-shaped supragingival exterior surface and is selected from the group consisting of
a) a premolar wherein the thickness is at least 1.50 mm; and
b) a molar wherein the thickness is at least 3 mm.

31. (canceled)

32. The preformed dental article of claim 30 wherein the preformed dental article comprises substantially tooth-shaped subgingival exterior surfaces.

33. The preformed dental article of claim 30 wherein the preformed dental article comprises substantially tooth-shaped gingival exterior surfaces.

34. The preformed dental article of claim 20 wherein the dental article has sufficient malleability to be formed in shape at a temperature of about 15° C. to 38° C.

35. The preformed dental article of claim 20 wherein the dental article comprises greater than 70 wt-% filler.

36. The preformed dental article of claim 20 wherein the dental article has a flexural strength of at least about 25 MPa after hardening.

37. The preformed dental article of claim 20 wherein the dental article comprises a crystalline resin component.

38. A kit comprising a plurality of preformed implant dental articles according to claim 20 wherein the implant dental articles correspond in size and shape to natural teeth selected from the group consisting of maxillary and mandibular central incisors, lateral incisors, canines, premolars, and molar teeth.

39-40. (canceled)

41. The preformed dental article of claim 20 wherein the dental article further comprises an abutment.

42. The preformed dental article of claim 41 wherein the abutment is made from a material selected from metal, plastic materials including plastics that further comprise an inorganic filler; and ceramic materials.

43. The preformed dental article of claim 41 wherein the dental article comprises a cylindrical or conical shaped cavity to provide access for attaching the dental abutment to an implant anchor with a screw.

44. The preformed dental article of claim 20 wherein the dental article consists solely of the sufficiently malleable material.

45. The preformed dental article of claim 20 wherein the dental article consists of an external portion that comprises the sufficiently malleable material and a different interior material.
